(19) United States
(12) Patent Application Publication
(10) Pub. No.: US 2017/0103163 A1
(43) Pub. Date: Apr. 13, 2017

(54) System and Method for a Cloud Enabled Health Record Exchange Engine

(71) Applicants: Paul Emanuel, Durham, NC (US); Clinton Racine, Durham, NC (US)

(72) Inventors: Paul Emanuel, Durham, NC (US); Clinton Racine, Durham, NC (US)

(21) Appl. No.: 14/880,963

(22) Filed: Oct. 12, 2015

(51) Int. Cl. G06F 19/00; G06F 17/30

(52) U.S. Cl. CPC G06F 19/322; G06F 17/30345

(57) ABSTRACT

This document presents a system and method for the support and exchange of standard-based information between Electronic Health Record (EHR) and Health information Exchange (HIE) and other systems that exchange patient health information. Behavioral Health providers are expected to adopt standard-based information exchanges without the benefit of financial incentives provided by the Center for Medicare and Medicaid Services (CMS) to those providers who demonstrate Meaningful Use of EHR systems. These providers require a cost-effective approach to interoperability that relies on open-source and standard-based software tools to leverage the collective investments of federal, state, and private sector stakeholders.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

To reduce the cost of interoperability, software components and methodologies must be produced that reduce the high cost of healthcare interoperability for systems that are sharing healthcare information using a diversity of “information formats” standards outlined by the Meaningful Use regulation such as:
Health Level 7 (HL7) Consolidated Clinical Document Architecture Templates (C-CDA) for document-based exchanges
HL7 Version 2.7.1 Profiles for Laboratory Results and Orders (LRI, LOI)
National Council for Prescription Drug Program (NCPDP) SCRIPT for exchanging medication prescriptions and processing medication history records
Workgroup for Electronic Data. Interchange (WEDI) X12 Implementation Guides for benefits eligibility checks, billing/insurance claims and prior authorization

Throughout this document, the term Interface Exchange Formats refers to the representation of information “on the wire” using standard formats such as HL7 Version 2, HL7 CDA, X12, NCPDP, National Information Exchange Model (NIEM), etc. This term is in contrast to the content of the information consisting of business-specific data elements.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an exemplary hardware system configuration of the ELXR system consistent with certain embodiments of the present invention.

FIG. 2 is a view of information record flow through the ELXR server consistent with certain embodiments of the present invention.

FIG. 3 is a view of the process flow for document translation from one record format to another record format consistent with certain embodiments of the present invention.

FIG. 4 is a view of data format translation and mapping consistent with certain embodiments of the present invention.

FIG. 5 is a view of the referent index mapping and transformed record storage consistent with certain embodiments of the present invention.

FIG. 6 is a flow diagram for transformation process flow consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “mobile device” refers to any handheld device such as, but not limited to, a smart phone, tablet, iPad, network computer, watch or any other device a user may carry when travelling from place to place and interact with one or more networks.

Reference throughout this document to Information Exchange Formats refers to the representation of information “on the wire” using standard formats such as Health Level 7 (HL7) Version 2, HL7 CDA, X12, NCPDP, National Information Exchange Model (NIEM), etc. The overall goal is to ensure that the semantic meaning of the information being exchanged is the same regardless of the information exchange format being used and the application deployment environment.

Reference throughout this document to C-CDA refers to the Consolidated Clinical Document Architecture for document-based exchanges as defined by HL7 standards. The C-CDA Release 2 implementation guide, in conjunction with the HL7 CDA Release 2 (CDA R2) standard, is to be used for implementing the following CDA documents and header constraints for clinical notes: Care Plan including Home Health Plan of Care (HHPoC), Consultation Note, Continuity of Care Document (CCD), Diagnostic Imaging Reports (DIR), Discharge Summary, History and Physical (H&P), Operative Note, Procedure Note, Progress Note, Referral Note, Transfer Summary, Unstructured Document, Patient Generated Document (US Realm Header).

Reference throughout this document to the Model Driven Messaging Interoperability (MDMI) Map refers to maps that relate local Electronic Health Record (EHR) or Health Information Exchange (HIE) source data to information exchange formats utilizing a Referent Index (RI).

Reference throughout this document to the RI refers to a set of domain-specific standards-based concepts that represent all of the vocabulary and data elements required when transferring data in one format to another format. The terms (vocabulary and data elements) in the RI are referenced as business elements by the MDMI.

Reference throughout this document to the MDMI Meta-Model refers to the three part data model composed of three sub-models: 1) a Syntax Meta-Model, 2) a Semantic Meta-Model, and 3) a Mapping Meta-Model.

Reference throughout this document to the Syntax Meta-Model refers to a model for defining the data format/data types and defines how to gather the data terms (vocabulary) in the source data format and/or to construct a target message in the correct syntax format from a set of data terms that were created in the transformation of any source message.

Reference throughout this document to the Semantic Meta-Model refers to the association of semantic elements to other semantic elements in a data format. The meaning of a specific field in a record can be dependent on the value in another field in that record. The Semantic Meta-Model insures that each semantic element in the data format provides precise semantic content by capturing all semantic information for each semantic element.

Reference throughout this document to the Mapping Meta-Model refers to the relation of the semantic elements in the data format to the business elements in the RI.

Historically, EHR systems evolved independently and without specific requirements to internally represent health information in any particular format or database design. With the introduction of Meaningful Use, the only requirement that certified EHR systems have to meet with respect to information exchange is to be able to send and receive selected portions of the health record using specific health IT interoperability and terminology standards.

Previous standard-based mapping projects aimed to facilitate transition from one standard information exchange structure and syntax to a new version (e.g., HL7 Version 2 ASCII Encoded messages to HL7 Version 3 XML messages). These projects attempted to map the entire standard to its newer version without any consideration to the fact that both versions required additional refinements (i.e., constraints) for real-world implementations. Base standards such as HL7 CDA, Version 2 and FHIR that define information exchange require additional constraints to become templates or profiles organized into implementation guides in order to be implementable. Due to the unconstrained definitions or built-in optionality of the base standards, mapping an entire standard from one format to another is unreliable. It is similar to mapping a base class to another base class while ignoring that each class must be further specialized prior to instantiation. This mapping approach fails to align semantically equivalent data elements because the interoperability standards contain generic concepts and optionality intended for adaptability to a multitude of implementations. Therefore, mapping base standards such as HL7 Version 2 to HL7 Version 3 or HL7 CDA to HL7 FHIR is inherently imprecise as relating one general data element definition to another does not capture the intended business meaning.

In an embodiment, mapping to a defined and agreed upon Referent Index increases the confidence that information being exchanged is understood by both sender and receiver. This basic understanding ultimately reduces the probability that the health information being exchanged will be ignored (due to questionable integrity of the information) or worse, that patient safety is compromised due to erroneous assumptions as the result of misinterpretation of the data being exchanged.

HIE organizations (HIEs) can provide incredible value if they use the Referent Index for storing the health information exchanged for patients from multiple provider sources using their own internal database structure. HIEs are key to reducing costs (due to repeating tests and missing information) and to improving the quality of care by helping to provide a longitudinal health record for individuals in the U.S. privatized health insurance environment where patients move from one health plan to another and/or receive care from multiple health systems. Even more importantly, patient safety can be improved by providing appropriate access to all of the health records for an individual stored in HIEs.

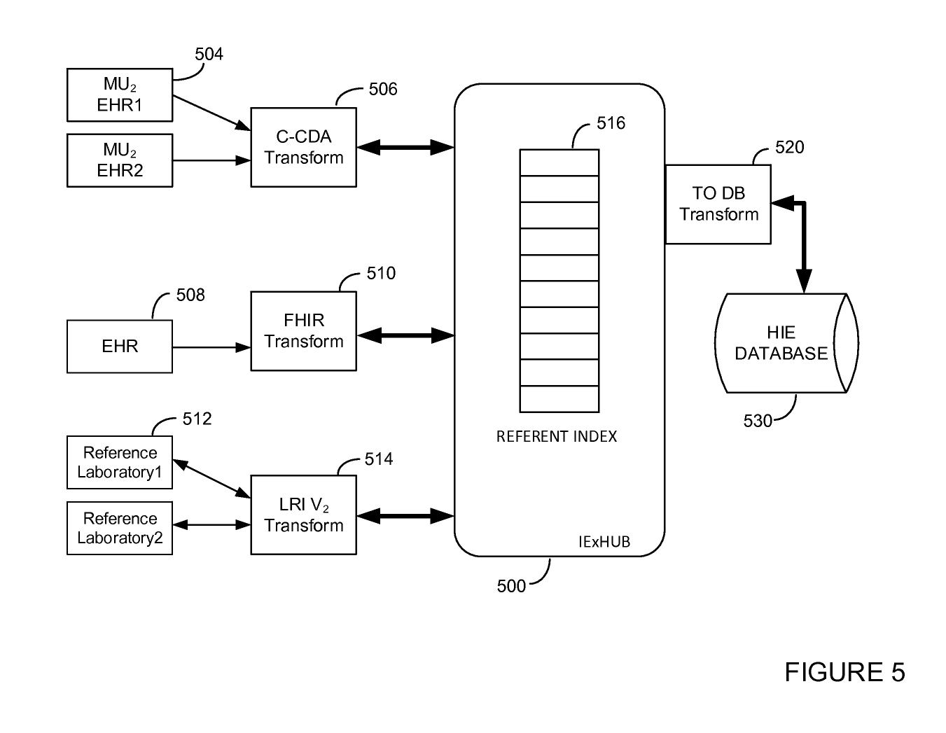

In another exemplary embodiment, another advantage of storing data in HIEs based on the Referent Index is that a provider using one EHR system can request information to be sent in its native information exchange format (e.g., as C-CDA document or FHIR resource) from the HIE where the data area based on aggregate information that originated from other EHR systems sending C-CDA documents, HL7 Version 2 messages, or NCPDP SCRIPT transactions. FIG. 5 illustrates how an EHR may request summary of information from an HIE that aggregates information received using a variety of information exchange formats that are mapped to a consistent Referent Index in a consistent HIE Database that follow the canonical structure of the data (i.e., Referent Index).

To alleviate performance concerns in operation of the system, the IExHub can also support a distributed architecture whereby IExHub capabilities are performed by local Electronic Health Record (EHR) systems. In this manner, each EHR system is responsible for its own data and information exchange format(s) transformation, providing for a more scalable system architecture.

The ELXR Cloud architecture proposes two sets of components intended to provide a clear separation of concerns throughout the development process between design and run-time interests. This separation of concerns has two benefits: (1) it increases the reuse potential of the software by allowing the functional specification to be reused with different non-functional requirements, and (2) facilitates the automated generation of infrastructure code addressing nonfunctional concerns pertaining to run-time behavior. In an exemplary embodiment, design time tools require robust, vetted models which allow us to develop better end-user tooling based on user feedback.

### ELXR Cloud (ELXR) Interoperability Architecture

The ELXR Interoperability Architecture separates design-time components from run-time components and adheres to a well-established software development principle known as separation of concerns. The structures, respective elements, and relationships of the architecture provide templates for concrete architectures in a particular domain or family of software systems that are created, maintained and managed in cloud-based servers.

The ELXR Interoperability Architecture prescribes the founding principles, underlying methodology and the architectural practices recognized by domain stakeholders as the baseline solution for the construction of a certain class of software systems in that domain. Symmetrically, the software architecture of one particular system for a given domain can then be regarded as an “instantiation” to the specific system needs of the reference software architecture for that domain.

The purpose of this architectural approach is to separate the representation of the data in the information exchange format (e.g., XML for CDA and FHIR; pipe and caret characters in HL7 Version 2) from the messaging protocol used to exchange the information across the wire (e.g., Representational State Transfer (REST), Simple Object Access Protocol (SOAP), File Transfer Protocol (FTP), secure email, HL7 Minimal Lower-Layer Protocol (MLLP)). This separation ensures that the semantic content of the information being exchanged is guaranteed regardless of the information exchange format and method in which the information is transmitted.

While technical interoperability currently exists to some degree, the meaning of information is not always communicated in a way that is meaningful. What is needed is a normalized information model and our design time components are intended to provide this missing link.

### Design-Time Components

Design-Time components are used to model the base standards upon which implementation guides can be developed and map local EHR system data to standards-based concepts. This ensures that EHR systems can exchange health information in a manner that guarantees the content of the information is understood across disparate systems, thereby allowing for semantic interoperability.

These components also enable the C-CDA Clinical Statement Template (e.g., Allergy/Intolerance Observation, Laboratory Result, Medication, etc.) definitions to be translated into equivalent Fast Healthcare Interoperability Resources (FHIR) Resource/Profile definitions ensuring backward compatibility from FHIR Resources to C-CDA templates. This allows EHR systems to exchange information in both formats.

### IExBench—Information Exchange Workbench

In an exemplary embodiment, the IExBench is an Information Exchange Workbench application for mapping information structures and creating model-based implementation guides for information exchange specifications. IExBench is comprised of two Open Health Tools Model-Driven Health Tools (OHT MDHT) components. The MDHT CDA workbench is used (1) to create re-usable templates; and (2) create CDA implementation guides based on C-CDA templates. Consumers and implementers of CDA document exchange are able to generate run-time components from models of the implementation guides, thus accelerating and lowering the cost of adoption for this key standard required in Meaningful Use Stage 2 (MU2) certification.

In this embodiment, during an initial evaluation, the MDHT tools were used to create implementation specifications for information exchange formats beyond the CDA format (i.e., including FHIR profiles) that are consistent with the data requirements for MU Stage2. The MDHT CDA tool provides a model-driven framework for generating a Java runtime Application Program Interface (API) that supports C-CDA templates and enables construction of instances that conform to one or more templates. The MDHT CDA tool also supports the validation of instances against the constraints defined in the model as well as consumption of those XML instances. Enhanced MDHT extensions can be used to specify constraints that are common across alternative information exchange formats represented in UML models.

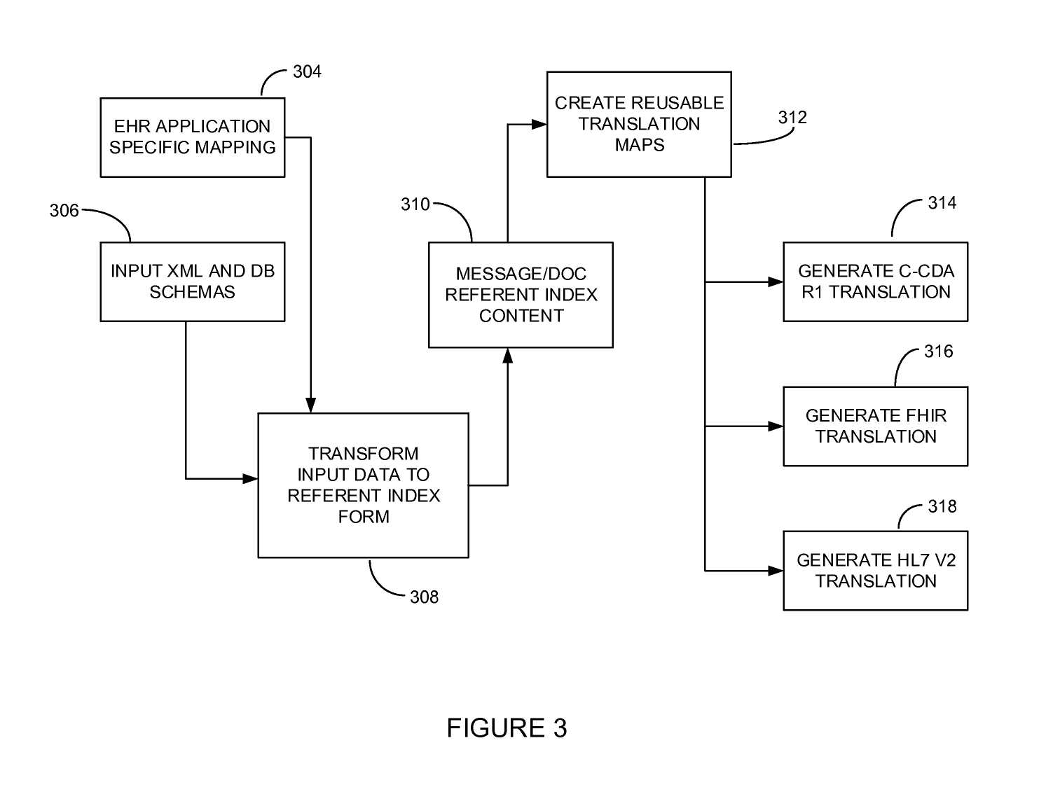

A second OHT MDHT component is the Model Driven Messaging Interoperability (MDMI) Map Editor, which will be described in full with respect to FIG. 3.

In an additional embodiment, IExBench may also be used to automate the creation of HL7 Fast Healthcare Interoperability Resources (FHIR) resources thus ensuring backwards compatibility to C-CDA Release 1.1 based on MDHT CDA models (using standard modeling tools: UML2, Eclipse Modeling Framework). The Open Health Tools (OHT) Model Driven Health Tools (MDHT) CDA tool is a standard-based UML 2.0 Modeling platform that currently supports Model-driven development of CDA Templates including C-CDA Release 1.1 and C-CDA Release 2.0, but other models may be added as needed.

IExBench will be enhanced to support model-driven development of FHIR profiles and for use with other UML models (e.g., HL7 Domain Analysis Models) such as the Behavioral Health Domain Analysis Model, used to enhance the domain-specific MDMI Referent Index, and to auto-generate XML-encoded FHIR profiles.

### Runtime Components:

In an embodiment, the runtime components consist of a general-purpose Information Exchange Hub (IExHub) that enables EHR systems to exchange protected health information (content) independent of information exchange formats (e.g., HL7 CDA, FHIR, Version 2.X, NIEM, etc.). The IExHub is a set of Java-based RESTful services implemented with an Apache Tomcat web/application server which converts local data into standard-based formats, such as Continuity of Care (CCD) documents based on Consolidated CDA (C-CDA) templates, Fast Health Interoperability Resources (FHIR) and other information exchange formats. The IExHub is also used to transform C-CDA documents into FHIR profiles or other equivalent information exchange formats so that EHR systems can send and receive in their preferred information exchange format.

This implementation focuses on REST because it is simple to implement, supports many different data formats (other than XML), has better performance and scalability than other transport methods and is being widely implemented today. Other transport methods will also benefit from this model-driven approach to mapping and the services provided by the IExHub.

In an additional embodiment, another runtime component is a sample EHR Application (IExApp) reference implementation that demonstrates how XML queries, inserts, and persistence (accounting for disclosures and data provenance) may be implemented. We envision that this architecture promotes the separation of concerns that enable the development of verifiable real-time software systems.

The IExHub is used to operationalize the transformation of local EHR system data to C-CDA, FHIR, etc., as well as to support the transformation of C-CDA documents into FHIR or other equivalent information exchange formats.

The IExHub executes the maps created by the IExBench. It maintains and keeps the mapping file provided by the EHR sample application persistent across the system and strings together the local data map to the Referent Index and from the Referent Index map to the desired information exchange format map. The IExHub supports bi-directional exchange through its RESTful services that provide data transformation services to EHR systems that want to exchange data in different formats without loss of information.

Additional exemplary embodiments may include implementation support for HL7 Version 2 to enable semantic interoperability for the exchange of clinical laboratory results and orders required by Meaningful Use. Other enhancements may include extending model-driven standard specifications (e.g., CDA templates, FHIR resources) derived UML models describing interoperability requirements (e.g., Quality Improvement and Clinical Knowledge (QUICK), Biomedical Research Integration Domain Group (BRIDG)) to ensure that CDA templates and FHIR profiles stay equivalent to meet United States-specific interoperability requirements.

Another area of enhancement is to use MDHT to generate both implementation guides and mapping models for run-time. Once an analysis model is used to create templates or profiles, the model information is sufficient to generate a map from the domain-specific model (e.g., HL7 DAM, Federal Health Information Model (FHIM), Clinical Information Modeling Initiative (CIMI)) to the information exchange format (e.g., CDA, FHIR). This enhancement assumes that the MDMI runtime allows for a new Referent Index to be imported into the Map Editor to be used to map local EHR data to the Referent Index based on the standard UML model (e.g., HL7 DAM, FHIM, or CIMI).

The system and method of healthcare record transformation is implemented in a network server comprising a processor connected to one or more input data sources that is operative to accept a plurality of input healthcare records in one or more input healthcare record formats. The system and method is operative in the processor to transform all incoming healthcare record formatting to an intermediate index format and captures the semantic meaning for all healthcare record data fields. The processor transforming said intermediate index formatting to one or more pre-requested output healthcare record formats and inserting captured semantic meaning into transformed data fields within said one or more requested output healthcare record formats. The system and method generates one or more transformed output healthcare records in one or more requested output healthcare record formats and displaying the transformed output healthcare records to a system user for additional recall and use in patient care.

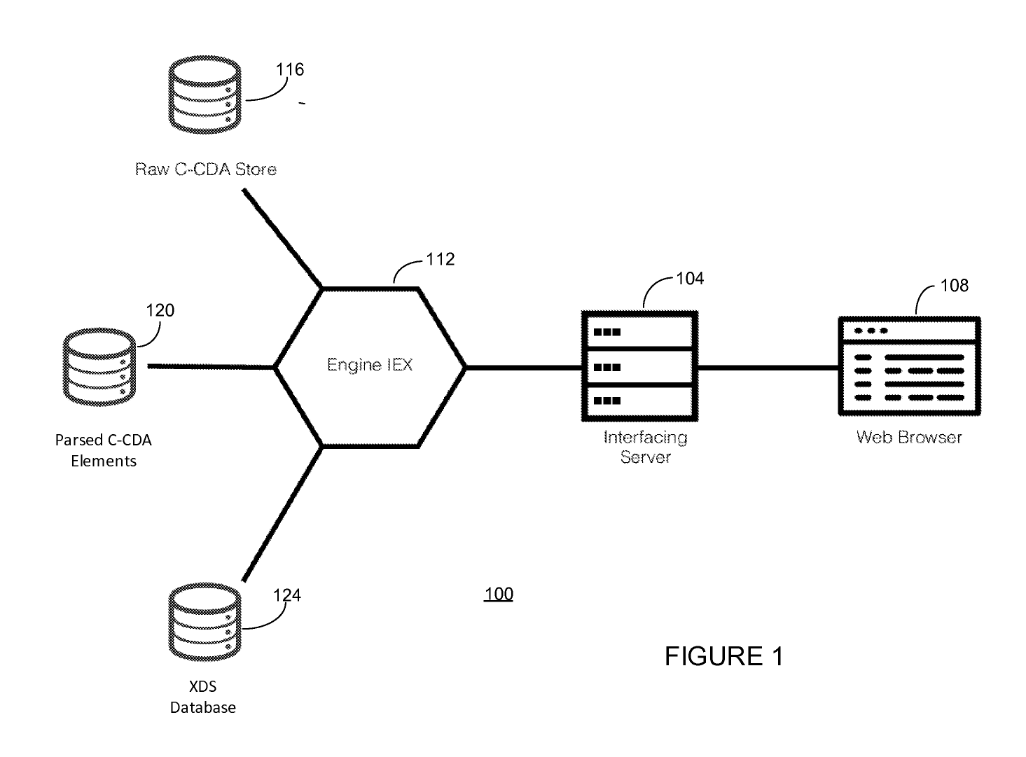

Turning now to FIG. 1, this figure presents a view of an exemplary hardware configuration of the ELXR system 100 consistent with certain embodiments of the present invention. In an exemplary embodiment, the system may comprise a server 104 to which outside access is permitted to one or more users through processors on which web browsers are operating 108. The web browser 108 may provide both public and secure access to the interface server 104 to permit users to interact with the ELXR system 100. Such interaction with the system may include logging in to the ELXR system 100 to submit documents, access database files, request services, or provide access to the IEX transformation engine 112.

In a non-limiting example, the IEX transformation engine 112 collects information from one or more clients accessing the interface server 104 through a web browser 108 session. The information transmitted from a user may comprise documents formatted in a C-CDA format and will be stored in a C-CDA data store 116 for later transformation actions. The IEX engine 112 may retrieve documents from the C-CDA data store 116 and begin the process of parsing the C-CDA formatted documents to place the information in a transitional, parsed C-CDA form and save the parsed C-CDA document elements into a parsed C-CDA data store 120. The parsed C-CDA document elements may be operated upon immediately, or may be retrieved from the parsed C-CDA data store 120 at a later time to transform the input C-CDA document into another document format. By way of example and not of limitation, the C-CDA document elements may be transformed into an XDS formatted document and saved in an XDS data store 124 for later retrieval and transmission to a user session operational on one, or more than one, web browser 108 connected to the ELXR system 100.

The foregoing example is just one example of the document format transformation capability of the ELXR system 100. Additional format transformations may include HL7 to HL7-2, HL7 CDA to HL7 FHIR, or from one of any standard or defined custom document format to any other standard or defined custom document format.

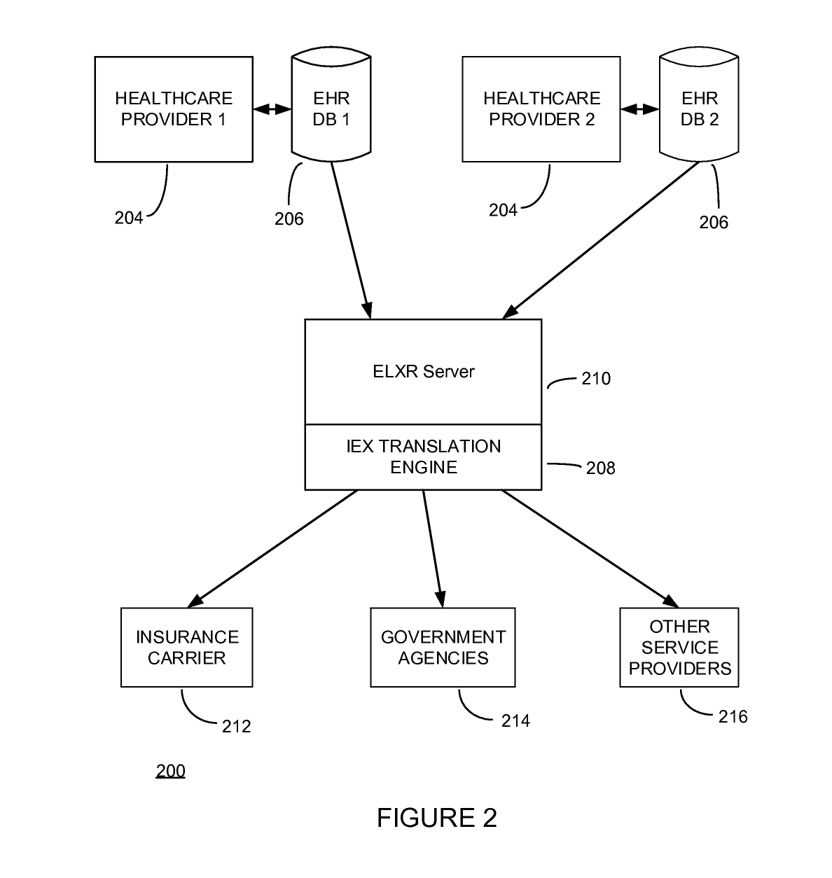

Turning now to FIG. 2, this figure presents a view of information record flow through the ELXR server consistent with certain embodiments of the present invention. In an exemplary embodiment, healthcare providers 204 must, by law, retain records for each person for whom they render healthcare services. However, the format, manner, or mode of data capture and record keeping is entirely within the control of each healthcare provider. Each healthcare provider, whether solo practitioner, medical partnership, clinic, or hospital, is permitted to determine what electronic record format best serves their need for information intake and management within each person's healthcare record.

Standard record formats, such as HL7, HL7 Version 2, X12, NCPDP, NIEM, and other record keeping formats refer to the representation of information that may be more readily exchanged between independent providers. Providers produce an Electronic Healthcare Record (EHR) for each individual for whom care is provided. These records are stored in one or more connected EHR databases 206 in the selected standard record format. An issue occurs when a healthcare provider 1 204 wishes to provide the healthcare record to other entities, institutions, or providers who maintain healthcare records in a standard record format different than the standard record format selected for use by healthcare provider 1 204.

In an exemplary embodiment, historically, producing a translation from one standard healthcare record format to a second standard healthcare record format has been time-consuming and expensive. However, in the instant invention, producing such a translation is enabled by the Information Exchange (IEX) Translation Engine 208 implemented on the ELXR Server 210 in a timelier manner and at lower cost through the implementation of flexible mapping and format translation. Additionally, a major issue with format translation can be the loss of semantic meaning from notes and other instructions that are stored within the standard record as part of a person's diagnosis and treatment.

In this exemplary embodiment, a healthcare provider 204 may be required to report healthcare information to entities such as insurance carriers 212, government agencies 214 for oversight purposes, or other service providers 216, each of which may maintain and process standard record formats that are different from that of a healthcare provider 204. A healthcare provider 204 may direct the transmission of healthcare records from the EHR database 206 maintained by the healthcare provider 204 to the IEX translation engine 208 to begin the process of transforming the standard healthcare record from the format chosen by the healthcare provider 204 to another healthcare record format, whether the second healthcare record format is a standard or proprietary healthcare record format. The IEX Translation Engine 208 is responsible for analyzing the incoming healthcare record format to determine the standard being employed, maintaining the semantic content for all text fields, mapping the incoming standard record format fields into a flat, normalized structure, and transforming the mapped standard record fields from the incoming standard record format into a record format that is required and accepted by the insurance carrier 212, government agency 214, or other service provider 216 who is the target of the transmission of the data from the healthcare provider 204.

In this exemplary embodiment, healthcare records, regardless of standard healthcare record format, may be transformed and transmitted to an entity who has requested the healthcare records in a format that is readily ingested and used by the requesting entity.

Turning now to FIG. 3, this figure presents a view of the process flow for document translation from one record format to another record format consistent with certain embodiments of the present invention. In an exemplary embodiment, the system presents as input an EHR record created by a specific mapping application in one particular format 304. The EHR records may be created in any format to which a practitioner or service provider maintains health records such as, in a non-limiting example, HL7, HL7 V2, C-CDA, or any other health record format found useable by a practitioner or service provider. Additional input to the system may comprise XML stylesheets containing medical information record structure and database schemata 306 to provide organizational and data structure information. The mapped EHR record 304 and XML and database schemata 306 are ingested as input to the transform function at 308. The transform function is operative to transform the input record, record structure, and data into Referent Index (RI) format and to create health care record message and document RI content 310.

In an exemplary embodiment, the system operates to create reusable translation maps from the RI content 312. Each translation map comprises the document structure, retained information meaning, and standard format to transform the specific input EHR record to another standard or customized record format. In a non-limiting example, an EHR record may be input in a standard record format such as HL7, and, after ingestion 308, transformation into RI content 310 and creation of a translation mapping 312, the input EHR record may be transformed and an output record may be generated in the C-CDA R1 standard record format 314, an FHIR standard record format 316, an HL7 V2 record format 318, or any other standard or customized record format for which the system can create a translation mapping.

In an exemplary embodiment, the translation maps created by the transformation system 312 may be used for subsequent records having the same input mapping, XML, and database schemata. In this manner, translation maps may be reusable for any number of records input to the transformation system.

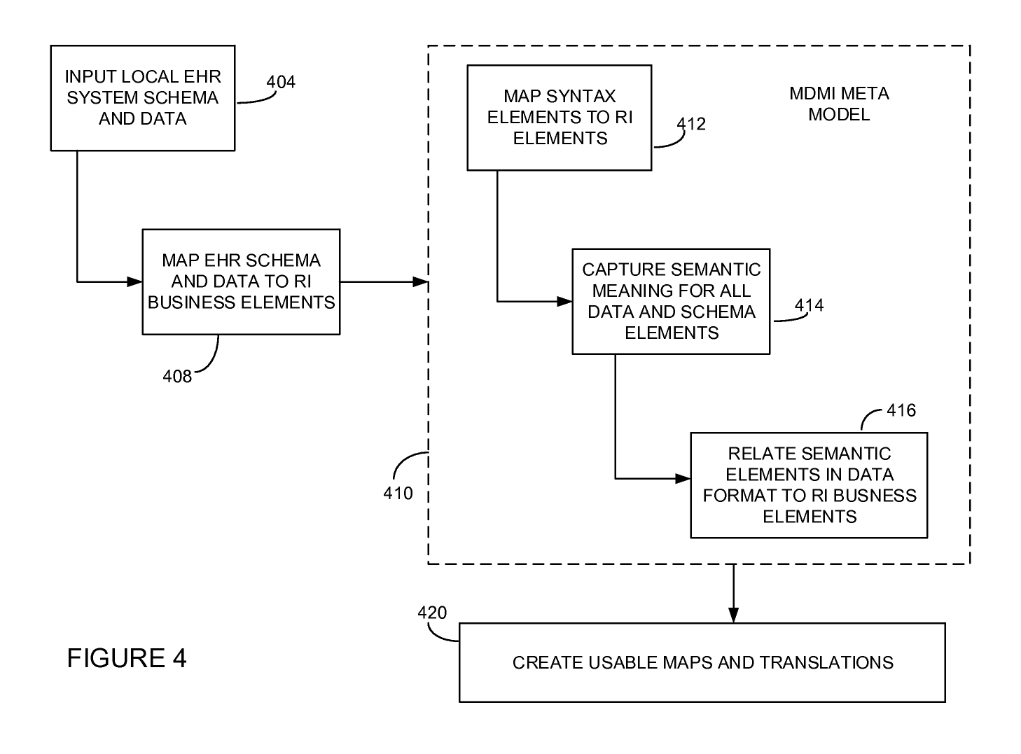

Turning now to FIG. 4, this figure presents a view of data format translation and mapping consistent with certain embodiments of the present invention. In an exemplary embodiment, the retention of semantic meaning and syntax are tremendously important to any transformation from one record format to any other. Simply transforming data fields from one data structure to another does not necessarily maintain the semantic meaning of data fields that depend upon other data fields within a record format. The transformation system maintains both syntax and semantic meaning of data fields when transforming an input health care record from a first format to a second record format that is different from the first record format. In addition, this process includes one or more mapping and syntax translation steps that permit the ELXR system to learn about the input record formats and schema during the creation and construction of an MDMI Meta Model. This learning process assists in the creation of usable maps and translations for standard and defined custom healthcare record formats for output to destination clients of the ELXR system.

In an exemplary embodiment, this process begins with the input of locally generated EHR schemata and data 404. In this embodiment, locally generated refers to EHR records generated in a standard format to which a service provider or practitioner adheres to in maintaining and managing healthcare records for that practice. Upon input to the transformation system, the EHR schemata and data are mapped to the Referent Index 408. The records are mapped through the operation of an Information Exchange Workbench application for mapping information structure and creating model-based implementation guides for information exchange specifications.

In an exemplary embodiment, the MDMI Meta Model 410 is an application that will perform mapping from a first standard record format to a second record format, without losing either syntax structure or semantic meaning through the mapping activity. The MDMI Meta Model 410 application allows an analyst to create or edit maps that relate local EHR/HIE source data to information exchange formats using a Referent Index (RI). Within the MDMI runtime environment two mapping steps are performed. The first step involves mapping local EHR system data elements to the RI 408. The RI is a set of domain-specific standards-based concepts that represent all the vocabulary, or data elements needed when transferring data in one format to another format. MDMI refers to the terms in the MDMI Referent Index as Business Elements.

The other mapping step is from the RI to the MDMI Meta-Model. The MDMI meta-model contains three distinct sub-models: (1) the Syntax Meta-Model, (2) the Semantic Meta-Model, and (3) the Mapping Meta-Model. The Syntax meta-model is used to define the data format (data types) and can be sued on any data format. When the mapping is complete, the map defines how to gather the data terms (the vocabulary) in the source data format and/or to construct a target message in the correct syntax from a set of standards-based data terms created in the transformation for the source message 412. The vocabulary for the specific data format is referred to as semantic elements to differentiate it from the business elements used in the RI.

In an exemplary embodiment, mapping the semantic meta-model is performed to capture the semantic meaning for all data and schema elements 414. The mapping activity first associates semantic elements to other semantic elements of the same data format. The meaning of specific field in a record can be dependent on the value in another field in that same record. The semantic meta-model is used to capture this information to insure that each semantic element in the data format is precise and that no semantic meaning of any data term is lost in the transformation from one record format to another.

In this embodiment, the MDMI mapping meta-model is used to relate semantic element in the data format to the business elements in the RI 416. A staged mapping approach is created, starting with data elements specific to an EHR system, and is first mapped to the Referent Index. Several possible maps, relating to Referent Index to a specific information exchange, may be invoked to translate the EHR data to a variety of formats. In a non-limiting example, one format translation may occur from C-CDA 1.1 to FHIR and HL& Version 2.x implementation guides.

In an exemplary embodiment, a major objective of this architecture is to create mappings that would express the Referent Index in different information exchange formats and to make these mappings available to any interested stakeholder in order to lower the cost of interoperability nationwide 420. This model-based approach can simplify and flatten the heavily nested information exchange structures when mapping local data to standard structures (e.g., C-CDA 1.1 templates) thus simplifying and improving the quality of standard-based interfaces.

Turning now to FIG. 5, this figure presents a view of the referent index mapping and transformed record storage consistent with certain embodiments of the present invention. In an exemplary embodiment, an IExHub 500 is operative to execute the maps created by the IExBench module. The IExHub 500 maintains the mapping file provided by an EHR sample application and builds a transformed healthcare record by concatenating the local data map with the RI map and maps the data from the RI map to the desired information exchange format map.

In an exemplary embodiment, the IExHub 500 is capable of executing a transformation from a plurality of incoming healthcare record maps into any desired information exchange format. In this embodiment, one or more Meaningful Use (MU2) Electronic Healthcare Records 504 may be input to an IExBench module to map and begin the transform activity into C-CDA format and mapping 506. Additionally, new resource Electronic Healthcare Records 408 may be input to the IExBench module to map and transform the new resource record into FHIR format 510. In an additional example, Reference Laboratory results may be transformed by the IExBench module to an LRI V₂ format 514 to be ingested by the IExHub 500.

In this exemplary embodiment, each input record has been transformed into a format that may then be mapped to RI 516 business elements. The RI 516 business elements are then mapped by the IExHub 500 into the preferred or desired information exchange format and transformed through the mapping into healthcare record results. The healthcare record results may be consolidated from the entirety of input sources, each using a different input format, and transformed in to a healthcare record that is database storage ready 520. The consolidated patient results may then be stored into a Healthcare Information Exchange database that is updated and maintained by the MDMI system.

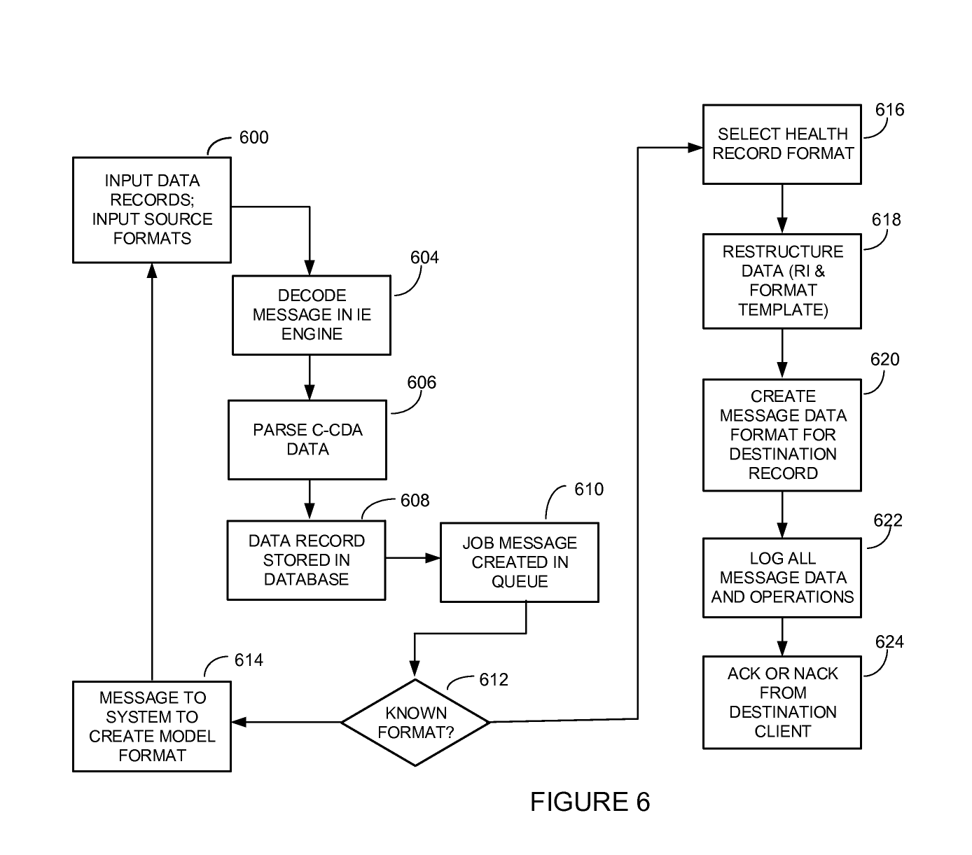

Turning now to FIG. 6, this figure presents a flow diagram for transformation process flow consistent with certain embodiments of the present invention. In this embodiment, data records are input to the ELXR system in one or more input formats. The input documents may be transmitted to the ELXR system either as documents formatted in any standard document format as defined by one or more of the standards organizations such as, in a non-limiting example, HL7, or as documents formatted in a defined custom format previously transmitted to the ELXR system 600. Upon receipt of the input data records from an input source, the incoming records are decoded by the IE engine 604. In an exemplary embodiment, the incoming data in a standard format, such as C-CDA, is parsed to create a parsed C-CDA record file 606 which is then stored into one or more database files 608.

In an exemplary embodiment, the IE engine creates a job message and places this job message into a work queue 610 for a pending transformation operation by the IEX Translation engine. The ELXR performs a check of the format into which the documents are to be transformed to determine if it is a known format 612. If the format is a custom format or a format that is not yet known to the ELXR system, a message is sent to a system operator indicating that a model format must be created 614 to complete the operation and the system returns to input data status to continue with the next record to be input.

If the format is a known standard or custom format, the system selects the health record format into which the input documents are to be transformed 616. The parsed data from the input records is restructured to create RI business elements for all elements in the parsed input records and a format template is constructed 618. The IEX translation engine then utilizes the RI business elements created for the input records to rebuild the health record by placing the RI business elements into the format template created for the destination healthcare record 620.

In an exemplary embodiment, all operations on the input records that were performed by the IEX translation engine to transform the input records from the input data format to the destination record format are logged within a log database maintained and managed by the ELXR system 622. The ELXR system then transmits the output records in the destination record format to the destination client. The ELXR system waits for an acknowledge (ACK) or a non-acknowledge (NACK) signal from the destination client to determine if the destination records have been received in the expected format by the destination client 624. An ACK signal indicates a successful transformation activity and an acceptance by the destination client. A NACK signal indicates that there are issues that must be addressed such that the transmitted records may be accepted by the destination client.

While certain illustrative embodiments have been described, it is evident that many alternatives, modifications, permutations and variations will become apparent to those skilled in the art in light of the foregoing description.

What is claimed is:

1. A system for healthcare record transformation, comprising:
a network server comprising a processor connected to one or more input data sources;
the processor operative to accept a plurality of input healthcare records in one or more input healthcare record formats;
a software module operative in the processor to transform all incoming healthcare record formatting to an intermediate index format;
the software module operative to capture semantic meaning for all healthcare record data fields;
a software module for transforming said intermediate index formatting to one or more pre-requested output healthcare record formats and inserting captured semantic meaning into transformed data fields within said one or more requested output healthcare record formats;
a software module for generating one or more transformed output healthcare records in one or more requested output healthcare record formats and displaying the transformed output healthcare records to a system user for additional recall and use in patient care.

2. A system as in claim 1, where the input healthcare record formats comprise electronic healthcare record schema and data fields.

3. A system as in claim 2, where the input healthcare record schema and data fields are transformed into referent index business elements.

4. A system as in claim 3, further comprising a software module operative to map syntax elements from the input healthcare record to referent index business elements.

5. A system as in claim 1, further comprising a software module operative to relate captured semantic meaning for all healthcare record data fields to referent index business elements.

6. A system as in claim 1, further comprising a software module operative to generate one or more translation mapping templates.

7. A system as in claim 6, where said one or more translation mapping templates further comprise mapping templates for standard healthcare record formats or pre-defined customized healthcare record formats.

8. A system as in claim 1, where said software module for generating one or more transformed output healthcare records is operative to create message data formatting and insert data from any one of the input healthcare records into a destination record created in a pre-selected output healthcare record format, where said destination record is transmitted to a client.

9. A system as in claim 1, further comprising logging all message data, input healthcare records, output healthcare records, and transformation and formatting operations to a logging database.

10. A system as in claim 8, where an acknowledgement or non-acknowledgement is received from the destination client by the server.

11. A method for healthcare record transformation, comprising:
accepting a plurality of input healthcare records in one or more input healthcare record formats within a healthcare translation module operating on a network server connected to one or more input data sources;
transforming all incoming healthcare record formatting to an intermediate index format;
capturing semantic meaning for all healthcare record data fields;
transforming said intermediate index formatting to one or more pre-requested output healthcare record formats and inserting captured semantic meaning into transformed data fields within said one or more requested output healthcare record formats;
generating one or more transformed output healthcare records in one or more requested output healthcare record formats.

12. A method as in claim 11, where the input healthcare record formats further comprise electronic healthcare record schema and data fields.

13. A method as in claim 12, where the input healthcare record schema and data fields are transformed into referent index business elements.

14. A method as in claim 13, further comprising mapping syntax elements from the input healthcare record to referent index business elements.

15. A method as in claim 11, further comprising relating captured semantic meaning for all healthcare record data fields to referent index business elements.

16. A method as in claim 11, further comprising generating one or more translation mapping templates.

17. A method as in claim 16, where said one or more translation mapping templates further comprise mapping templates for standard healthcare record formats or pre-defined customized healthcare record formats.

18. A method as in claim 11, where generating one or more transformed output healthcare records is operative to create message data formatting and insert data from any one of the input healthcare records into a destination record created in a pre-selected output healthcare record format, where said destination record is transmitted to a client.

19. A method as in claim 11, further comprising logging all message data, input healthcare records, output healthcare records, and transformation and formatting operations to a logging database.

20. A method as in claim 18, where receiving an acknowledgement or non-acknowledgement from the destination client by the server.
